(19) United States
(12) Patent Application Publication
(10) Pub. No.: US 2022/0019006 A1
(43) Pub. Date: Jan. 20, 2022

(54) COLOR FILTER

(71) Applicant: DIC Corporation, Tokyo (JP)

(72) Inventors: Shinya Sasaki, Sakura-shi, Chiba (JP); Hirotomo Sasaki, Sakura-shi, Chiba (JP)

(73) Assignee: DIC Corporation, Tokyo (JP)

(21) Appl. No.: 17/294,747

(22) PCT Filed: Nov. 27, 2019
(86) PCT No.: PCT/JP2019/046439

§ 371 Date: May 18, 2021

(30) Foreign Application Priority Data
Nov. 30, 2018 (JP) 2018-224929

(51) Int. Cl. G02B 5/22

(52) U.S. Cl. CPC G02B 5/22

(57) ABSTRACT

An aspect of the present invention is a color filter for converting an incident light from one surface of the color filter to a light having a wavelength different from that of the incident light and permitting the converted light to exit from another surface of the color filter, the color filter comprising: a bank having a plurality of opening portions and being formed to extend from the another surface to the one surface of the color filter; a plurality of pixel portions formed in the respective opening portions; and a reflective film formed so as to cover at least part of the side of the bank.

### TECHNICAL FIELD

The present invention relates to a color filter.

### BACKGROUND ART

A color filter for a display, such as a liquid crystal display device, has a plurality of picture element (pixel) portions (color filter pixel portions), such as a red pixel portion, a green pixel portion, and a blue pixel portion, and a conversion layer for converting an incident light from a light source to a light having a wavelength different from that of the incident light is formed in part of or all of the pixel portions. Further, generally, these pixel portions have formed therebetween a bank which separates the adjacent pixel portions from each other for the purpose of, for example, preventing the colors of lights from being mixed. In recent years, the use of light-emitting nanocrystalline particles, such as quantum dots, in the conversion layer of a color filter is studied (for example, PTL 1).

### CITATION LIST

### Patent Literature

PTL 1: U.S. Patent Application Publication No. 2017/0153366

### SUMMARY OF INVENTION

### Technical Problem

The color filter using light-emitting nanocrystalline particles is required to convert an incident light to a light having a wavelength different from that of the incident light and permit the converted light to efficiently exit from the color filter (to improve the light conversion efficiency). For meeting such a requirement, studies are made on, for example, optimization of the construction of the light-emitting nanocrystalline particles and the constituents of a composition containing the light-emitting nanocrystalline particles, but the light conversion efficiency can be improved from other points of view.

Accordingly, an object of the present invention is to improve a color filter using light-emitting nanocrystalline particles in the light conversion efficiency.

### Solution to Problem

An aspect of the present invention is directed to a color filter for converting an incident light from one surface of the color filter to a light having a wavelength different from that of the incident and permitting the converted light to exit from another surface of the color filter, the color filter comprising: a bank having a plurality of opening portions and being formed to extend from the another surface (exit surface) to the one surface (incidence surface) of the color filter; a plurality of pixel portions formed in the respective opening portions; and a reflective film formed so as to cover at least part of the side of the bank, the pixel portions having a pixel portion having a conversion layer containing light-emitting nanocrystalline particles, wherein the ratio of the height of the bank to the width of the bank is 0.5 or more, and wherein the angle between the side of the bank and the another surface of the color filter is 60 to 90°.

In the color filter, a reflective film is formed on the side of the bank, and therefore the probability of the phenomenon that the light entering the pixel portions (incident light) is reflected by the reflective film and absorbed and converted by the light-emitting nanocrystalline particles is improved, and further the probability of the phenomenon that the light having a wavelength converted by the light-emitting nanocrystalline particles (converted light) is reflected by the reflective film and permitted to exit from the color filter (the amount of the exit light) is also improved. Accordingly, when the reflective film is formed, absorption of the light (incident light and converted light) by the bank is suppressed, as compared to that in the case where the reflective film is not formed, making it possible to improve the light conversion efficiency (the ratio of the exit light to the incident light). Further, in the color filter, the ratio of the height of the bank to the width of the bank (aspect ratio: height/width) is 0.5 or more, and thus the bank is relatively high, so that the pixel portion having a conversion layer can have an increased thickness. Thus, the amount of the light-emitting nanocrystalline particles contained in the conversion layer can be increased, improving the probability of the phenomenon that the incident light is absorbed and converted by the light-emitting nanocrystalline particles. Furthermore, in the color filter, the oblique angle of the side of the bank is 60 to 90°. Therefore, when the width of the bank on the surface side which a light enters (incidence surface) is the same, the area ratio of the pixel portions to the surface from which the light exits (exit surface) (opening ratio) can be increased to improve the amount of the exit light, as compared to that in the case where the angle is less than 60°, and further the reflective film can be advantageously formed, as compared to that in the case where the angle is more than 90°, so that the above-mentioned improvement effect for the light conversion efficiency by the reflective film can be advantageously obtained.

In the color filter, a colored layer for transmitting the light converted by the conversion layer and absorbing the incident light may be formed on the conversion layer on the another surface side of the color filter. In this case, the color reproducibility of the color filter can be improved. Specifically, for example, when a blue light or a semi-white light having a peak at 450 nm is used as the incident light, the incident light is disadvantageously likely to pass through the conversion layer. In such a case, there is a concern that the incident light and the light which the light-emitting nanocrystalline particles emit (converted light) are mixed in color, leading to a lowering of the color reproducibility. Meanwhile, when the colored layer is formed on the conversion layer on the another surface side of the color filter, the incident light is shut out and only the converted light passes through the conversion layer, so that a lowering of the color reproducibility of the color filter can be suppressed.

In the color filter, a barrier layer for protecting the conversion layer may be formed on the conversion layer on the one surface side of the color filter. When the barrier layer is formed on the surface of the conversion layer on the light incidence surface side, a contact of the conversion layer with substances in air (such as water and oxygen) can be suppressed by the barrier layer, and therefore deterioration of the conversion layer can be suppressed, enabling protection of the conversion layer.

### Advantageous Effects of Invention

By the present invention, it is possible to improve a color filter using light-emitting nanocrystalline particles in the light conversion efficiency.

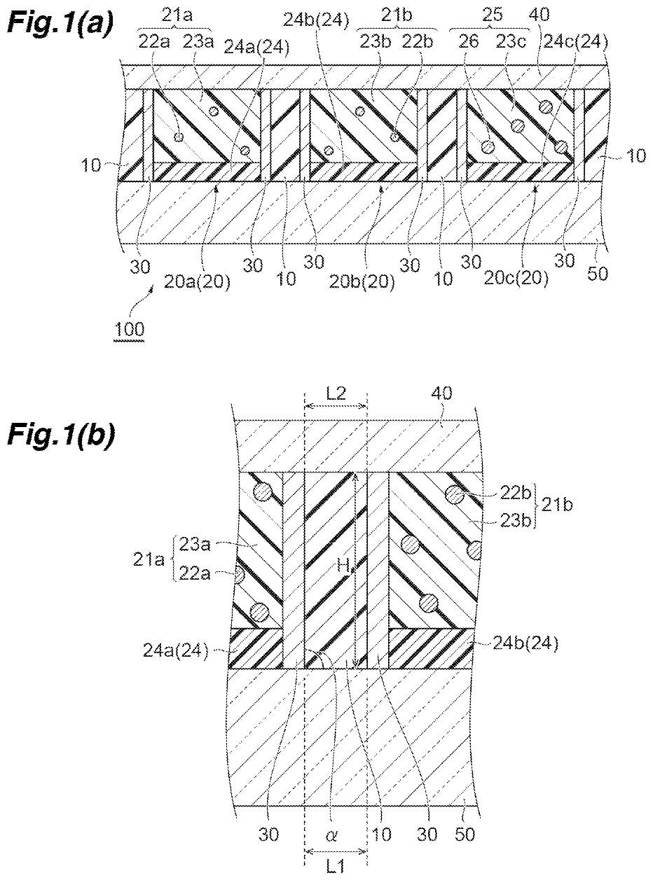

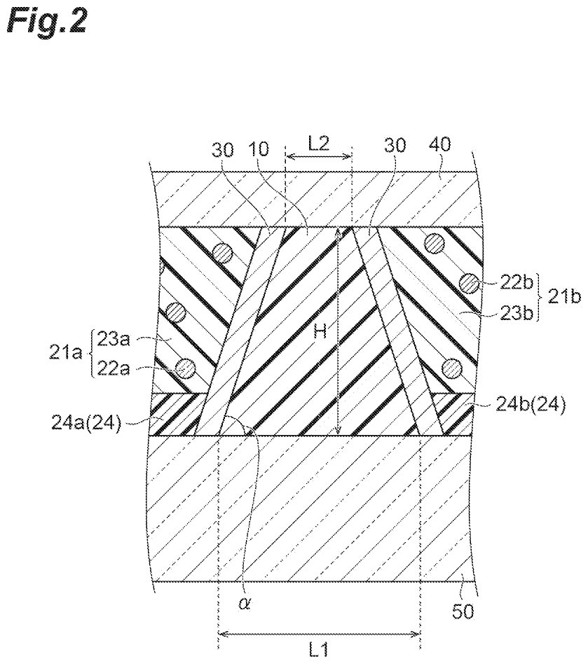

### BRIEF DESCRIPTION OF DRAWINGS

[FIG. 1] FIG. 1(a) is a diagrammatic cross-sectional view of a color filter according to an embodiment, and FIG. 1(b) is a cross-sectional view of an essential portion of FIG. 1(a).

[FIG. 2] A cross-sectional view of an essential portion of a color filter according to another embodiment.

### DESCRIPTION OF EMBODIMENTS

Hereinbelow, embodiments of the present invention will be described in detail with reference to the drawings. In the drawings, like parts or portions are indicated by like reference numerals, and repeated description is avoided.

FIG. 1 is a diagrammatic cross-sectional view showing a color filter according to an embodiment. As shown in FIG. 1(a), a color filter 100 according to an embodiment comprises a bank 10, a plurality of pixel portions 20, a reflective film 30, a barrier layer 40, and a substrate 50. The bank 10, pixel portions 20, and reflective film 30 are formed on one surface of the barrier layer 40. In the color filter 100, the side on which the barrier layer 40 is disposed corresponds to the incidence surface for light, and the side on which the substrate 50 is disposed corresponds to the exit surface for light.

The bank 10 is formed to extend from another surface (exit surface) to one surface (incidence surface) of the color filter 100. The bank 10 can be formed to extend from one surface (incidence surface) to another surface (exit surface) of the color filter 100. The bank 10 has a plurality of opening portions two-dimensionally arranged, as viewed on a plane, and collectively has a planar form in a lattice pattern. A plurality of pixel portions 20 are formed in the respective opening portions of the bank 10.

The pixel portions 20 have a first pixel portion 20a, a second pixel portion 20b, and a third pixel portion 20c. The first pixel portion 20a, second pixel portion 20b, and third pixel portion 20c are arranged in a lattice pattern so that they are repeated in this order. The bank 10 is present between the adjacent pixel portions, that is, the bank 10 is present between the first pixel portion 20a and the second pixel portion 20b, between the second pixel portion 20b and the third pixel portion 20c, and between the third pixel portion 20c and the first pixel portion 20a. In other words, the adjacent pixel portions are separated by the bank 10.

The bank 10 may be formed from a known material used in a bank, and, for example, may be formed from a resin (a cured product of a resin). The material constituting the bank 10 may be, for example, a material such that a film (bank) having a thickness of 10 μm formed from the material has a minimum transmittance at 380 to 780 nm of 50% or less, 30% or less, or 10% or less (e.g., a colored resin having an absorption in the visible light region (380 to 780 nm)), and may be a material such that a film (bank) having a thickness of 10 μm formed from the material has a minimum transmittance at 380 to 780 nm of 50% or more, 70% or more, or 90% or more (e.g., a transparent resin having absorption in the visible light region), and preferred is the latter material.

FIG. 1(b) is a cross-sectional view of an essential portion showing a portion around the bank 10 of FIG. 1(a). As shown in FIG. 1(b), in the color filter 100 according to an embodiment, the angle α between the side of the bank 10 and the exit surface for light (the surface of the substrate 50 on which the bank 10 is formed) is 90° (the bank 10 has a vertical tapered shape). FIG. 2 is a cross-sectional view of an essential portion showing a portion around a bank 10 of a color filter according to another embodiment. As shown in FIG. 2, in the color filter according to another embodiment, the side of the bank 10 may slant with respect to the exit surface for light (the surface of the substrate 50 on which the bank 10 is formed). The angle α between the side of the bank 10 and the exit surface for light (the surface of the substrate 50 on which the bank 10 is formed) is 60 to less than 90° (the bank 10 has a forward tapered shape at a predetermined oblique angle).

As mentioned above, the angle α between the side of the bank 10 and the exit surface for light (the surface of the substrate 50 on which the bank 10 is formed) is 60 to 90°. In the case where the angle α is 60 to 90°, when the width L2 of the bank on the surface side which a light enters (incidence surface) is the same, the area ratio of the pixel portions 20 to the surface from which the light exits (exit surface) (opening ratio) can be increased to improve the amount of the exit light, as compared to that in the case where the angle is less than 60°. Further, in this case, the reflective film 30 can be easily formed, and thus the reflective film 30 can be advantageously formed, as compared to that in the case where the angle is more than 90° (the bank has a reverse tapered shape) so that the improvement effect for the light conversion efficiency by the reflective film 30 can be advantageously obtained.

The angle α between the side of the bank 10 and the exit surface for light (the surface of the substrate 50 on which the bank 10 is formed) may be 60° or more, 70° or more, or 80° or more, and may be 85° or less, and may be 60 to 85°, 70 to 90°, 70 to less than 90°, 70 to 85°, 80 to 90°, 80 to less than 90°, or 80 to 85°.

The width L1 of the lower bottom of the bank 10 (length of the bank 10, as viewed with respect to the surface in contact with the substrate 50, in the direction perpendicular to the extending direction of the bank 10) may be 1 μm or more, 5 μm or more, 10 μm or more, 15 μm or more, or 18 μm or more, and may be 50 μm or less, 40 μm or less, 30 μm or less, or 25 μm or less.

The width L2 of the upper bottom of the bank 10 (length of the bank 10, as viewed with respect to the surface in contact with the barrier layer 40, in the direction perpendicular to the extending direction of the bank 10) is equivalent to the width L1 of the lower bottom or smaller than the width L1 of the lower bottom. The width L2 of the upper bottom of the bank 10 may be 1 μm or more, 5 μm or more, 10 μm or more, 15 μm or more, or 18 μm or more, and may be 50 μm or less, 40 μm or less, 30 μm or less, or 25 μm or less.

The height H of the bank 10 is the smallest distance between the lower bottom and the upper bottom of the bank 10. The height H of the bank 10 may be 1 μm or more, 5 μm or more, 7 μm or more, or 9 μm or more, and may be 30 μm or less, 15 μm or less, 13 μm or less, or 11 μm or less.

The aspect ratio of the bank 10 means the ratio of the height H of the bank 10 to the width L1 of the lower bottom of the bank 10 (H/L1). The aspect ratio of the bank 10 is 0.5 or more, and may be, for example, 0.6 or more, 0.8 or more, or 1.0 or more, and may be 1.5 or less, 1.0 or less, 0.8 or less, or 0.6 or less. When the aspect ratio of the bank 10 is in the above range, the pixel portion having a conversion layer can be increased in thickness, facilitating formation of pixel portions that can efficiently utilize the incident light.

The first pixel portion 20a has a first conversion layer 21a containing a first resin 23a and first light-emitting nanocrystalline particles 22a dispersed in the first resin 23a. The first light-emitting nanocrystalline particles 22a are red light-emitting nanocrystalline particles which absorb a light having a wavelength in the range of 420 to 480 nm to emit a light having an emission peak wavelength in the range of 605 to 665 nm. In other words, the first pixel portion 20a is a red pixel portion having the first conversion layer 21a for converting a blue light to a red light.

The second pixel portion 20b has a second conversion layer 21b containing a second resin 23b and second light-emitting nanocrystalline particles 22b dispersed in the second resin 23b. The second light-emitting nanocrystalline particles 22b are green light-emitting nanocrystalline particles which absorb a light having a wavelength in the range of 420 to 480 nm to emit a light having an emission peak wavelength in the range of 500 to 560 nm. In other words, the second pixel portion 20b is a green pixel portion having the second conversion layer 21b for converting a blue light to a green light.

The light-emitting nanocrystalline particles are nanometer-size crystals that absorb an excitation light to emit fluorescence or phosphorescence, for example, crystals having a maximum particle diameter of 100 nm or less, as measured by a transmission electron microscope or a scanning electron microscope.

For example, when absorbing a light having a predetermined wavelength, the light-emitting nanocrystalline particles can emit a light having a wavelength different from the wavelength of the light which the particles have absorbed (fluorescence or phosphorescence). The light-emitting nanocrystalline particles may be red light-emitting nanocrystalline particles which emit a light having an emission peak wavelength in the range of 605 to 665 nm (red light) (red light-emitting nanocrystalline particles), and may be green light-emitting nanocrystalline particles which emit a light having an emission peak wavelength in the range of 500 to 560 nm (green light) (green light-emitting nanocrystalline particles), and may be blue light-emitting nanocrystalline particles which emit a light having an emission peak wavelength in the range of 420 to 480 nm (blue light) (blue light-emitting nanocrystalline particles). In the present embodiment, the ink composition preferably contains at least one member of the above light-emitting nanocrystalline particles. Further, the light which the light-emitting nanocrystalline particles absorb may be, for example, a light having a wavelength in the range of 400 to less than 500 nm (blue light), or a light having a wavelength in the range of 200 to 400 nm (ultraviolet light). The emission peak wavelength of the light-emitting nanocrystalline particles can be found by, for example, a fluorescence spectrum or phosphorescence spectrum measured using a spectrofluorophotometer.

The red light-emitting nanocrystalline particles preferably have an emission peak wavelength of 665 nm or less, 663 nm or less, 660 nm or less, 658 nm or less, 655 nm or less, 653 nm or less, 651 nm or less, 650 nm or less, 647 nm or less, 645 nm or less, 643 nm or less, 640 nm or less, 637 nm or less, 635 nm or less, 632 nm or less, or 630 nm or less, and preferably have an emission peak wavelength of 628 nm or more, 625 nm or more, 623 nm or more, 620 nm or more, 615 nm or more, 610 nm or more, 607 nm or more, or 605 nm or more. The above-mentioned upper limit and lower limit can be arbitrarily employed in combination. In the following similar description for the range, the individual upper limit and the individual lower limit can be arbitrarily employed in combination.

The green light-emitting nanocrystalline particles preferably have an emission peak wavelength of 560 nm or less, 557 nm or less, 555 nm or less, 550 nm or less, 547 nm or less, 545 nm or less, 543 nm or less, 540 nm or less, 537 nm or less, 535 nm or less, 532 nm or less, or 530 nm or less, and preferably have an emission peak wavelength of 528 nm or more, 525 nm or more, 523 nm or more, 520 nm or more, 515 nm or more, 510 nm or more, 507 nm or more, 505 nm or more, 503 nm or more, or 500 nm or more.

The blue light-emitting nanocrystalline particles preferably have an emission peak wavelength of 480 nm or less, 477 nm or less, 475 nm or less, 470 nm or less, 467 nm or less, 465 nm or less, 463 nm or less, 460 nm or less, 457 nm or less, 455 nm or less, 452 nm or less, or 450 nm or less, and preferably have an emission peak wavelength of 450 nm or more, 445 nm or more, 440 nm or more, 435 nm or more, 430 nm or more, 428 nm or more, 425 nm or more, 422 nm or more, or 420 nm or more.

According to the solution of the Schrödinger's wave equation of a square-well potential model, the wavelength of the light that the light-emitting nanocrystalline particles emit (luminescent color) depends on the size (for example, particle diameter) of the light-emitting nanocrystalline particles, but also depends on the energy gap of the light-emitting nanocrystalline particles. Therefore, the luminescent color can be selected by changing the constituent material for and the size of the light-emitting nanocrystalline particles used.

The light-emitting nanocrystalline particles may be light-emitting nanocrystalline particles containing a semiconductor material (light-emitting semiconductor nanocrystalline particles). Examples of light-emitting semiconductor nanocrystalline particles include quantum dots and quantum rods. Of these, quantum dots are preferred from the viewpoint of easy control of the emission spectrum and reducing the production cost while surely achieving the reliability to improve the mass-productivity.

The light-emitting semiconductor nanocrystalline particles may have only a core containing a first semiconductor material, and may have a core containing a first semiconductor material and a shell containing a second semiconductor material different from the first semiconductor material and covering at least part of the core. In other words, the structure of the light-emitting semiconductor nanocrystalline particles may be a structure composed only of a core (core structure) and may be a structure composed of a core and a shell (core-shell structure). Further, the light-emitting semiconductor nanocrystalline particles may further have, in addition to the shell containing the second semiconductor material (first shell), a shell (second shell) containing a third semiconductor material different from the first and second semiconductor materials and covering at least part of the core. In other words, the structure of the light-emitting semiconductor nanocrystalline particles may be a structure composed of a core, a first shell, and a second shell (core-shell-shell structure). Each of the core and the shell may be a mixed crystal containing two or more semiconductor materials (for example, CdSe+CdS, or CIS+ZnS).

The light-emitting nanocrystalline particles preferably contain, as a semiconductor material, at least one semiconductor material selected from the group consisting of a Group II-VI semiconductor, a Group III-V semiconductor, a Group I-III-VI semiconductor, a Group IV semiconductor, and a Group I-II-IV-VI semiconductor.

Specific examples of semiconductor materials include CdS, CdSe, CdTe, ZnS, ZnSe, ZnTe, ZnO, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, CdHgZnTe, CdZnSeS, CdZnSeTe, CdZnSTe, CdHgSeS, CdHgSeTe, CdHgSTe, HgZnSeS, HgZnSeTe, HgZnSTe; GaN, GaP, GaAs, GaSb, AlN, AlP, AlAs AlSb, InN, InP, InAs, InSb, GaNP, GaNAs, GaNSb, GaPAs, GaPSb, AlNP, AlNAs, AlNSb, AlPAs, AlPSb, InNP, InNAs, InNSb, InPAs, InPSb, GaAlNP, GaAlNAs, GaAlNSb, GaAlPAs, GaAlPSb, GaInNP, GaInNAs, GaInNSb, GaInPAs, GaInPSb, InAINP, InAlNAs, InAlNSb, InAlPAs, InAIPSb; SnS, SnSe, SnTe, PbS, PbSe, PbTe, SnSeS, SnSeTe, SnSTe, PbSeS, PbSeTe, PbSTe, SnPbS, SnPbSe, SnPbTe, SnPbSSe, SnPbSeTe, SnPbSTe; Si, Ge, SiC, SiGe, AgInSe₂, CuGaSe₂, CuInS₂, CuGaS₂, CuInSe₂, AgInS₂, AgGaSe₂, AgGaS₂, C, Si, and Ge. From the viewpoint of easy control of the emission spectrum and reducing the production cost while surely achieving the reliability to improve the mass-productivity, the light-emitting semiconductor nanocrystalline particles preferably contain at least one member selected from the group consisting of CdS, CdSe, CdTe, ZnS, ZnSe, ZnTe, ZnO, HgS, HgSe, HgTe, InP, InAs, InSb, GaP, GaAs, GaSb, AgInS₂, AgInSe₂, AgInTe₂, AgGaS₂, AgGaSe₂, AgGaTe₂, CuInS₂, CuInSe₂, CuInTe₂, CuGaS₂, CuGaSe₂, CuGaTe₂, Si, C, Ge, and Cu₂ZnSnS₄.

Examples of the red light-emitting semiconductor nanocrystalline particles include CdSe nanocrystalline particles; nanocrystalline particles having a core-shell structure in which the shell part is CdS and the core part present on the inner side is CdSe; nanocrystalline particles having a core-shell structure in which the shell part is CdS and the core part present on the inner side is ZnSe; nanocrystalline particles of a mixed crystal of CdSe and ZnS; InP nanocrystalline particles; nanocrystalline particles having a core-shell structure in which the shell part is ZnS and the core part present on the inner side is InP; nanocrystalline particles having a core-shell structure in which the shell part is a mixed crystal of ZnS and ZnSe and the core part present on the inner side is InP; nanocrystalline particles of a mixed crystal of CdSe and CdS; nanocrystalline particles of a mixed crystal of ZnSe and CdS; nanocrystalline particles having a core-shell-shell structure in which the first shell part is ZnSe, the second shell part is ZnS, and the core part present on the inner side is InP; and nanocrystalline particles having a core-shell-shell structure in which the first shell part is a mixed crystal of ZnS and ZnSe, the second shell part is ZnS, and the core part present on the inner side is InP.

Examples of the green light-emitting semiconductor nanocrystalline particles include CdSe nanocrystalline particles; nanocrystalline particles of a mixed crystal of CdSe and ZnS; nanocrystalline particles having a core-shell structure in which the shell part is ZnS and the core part present on the inner side is InP; nanocrystalline particles having a core-shell structure in which the shell part is a mixed crystal of ZnS and ZnSe and the core part present on the inner side is InP; nanocrystalline particles having a core-shell-shell structure in which the first shell part is ZnSe, the second shell part is ZnS, and the core part present on the inner side is InP; and nanocrystalline particles having a core-shell-shell structure in which the first shell part is a mixed crystal of ZnS and ZnSe, the second shell part is ZnS, and the core part present on the inner side is InP.

Examples of the blue light-emitting semiconductor nanocrystalline particles include ZnSe nanocrystalline particles; ZnS nanocrystalline particles; nanocrystalline particles having a core-shell structure in which the shell part is ZnSe and the core part present on the inner side is ZnS; CdS nanocrystalline particles; nanocrystalline particles having a core-shell structure in which the shell part is ZnS and the core part present on the inner side is InP; nanocrystalline particles having a core-shell structure in which the shell part is a mixed crystal of ZnS and ZnSe and the core part present on the inner side is InP; nanocrystalline particles having a core-shell-shell structure in which the first shell part is ZnSe, the second shell part is ZnS, and the core part present on the inner side is InP; and nanocrystalline particles having a core-shell-shell structure in which the first shell part is a mixed crystal of ZnS and ZnSe, the second shell part is ZnS, and the core part present on the inner side is InP. With respect to the semiconductor nanocrystalline particles having the same chemical composition, by changing the average particle diameter of the particles, the color of the light that the particles emit can be changed to red or green. Further, with respect to the semiconductor nanocrystalline particles, those which have as small an adverse effect on a human body and the like as possible are preferably used. When semiconductor nanocrystalline particles containing cadmium, selenium, or the like are used as the light-emitting nanocrystalline particles, it is preferred that the semiconductor nanocrystalline particles containing the above-mentioned element (such as cadmium or selenium) in as small an amount as possible are selected and solely used, or the semiconductor nanocrystalline particles and other light-emitting nanocrystalline particles are used in combination so that the amount of the above-mentioned element contained becomes as small as possible.

With respect to the shape of the light-emitting nanocrystalline particles, there is no particular limitation, and the light-emitting nanocrystalline particles may have an arbitrary geometric shape, and may have an arbitrary irregular shape. The shape of the light-emitting nanocrystalline particles may be, for example, a spherical shape, an ellipsoidal shape, a pyramidal shape, a disc shape, a branched shape, a net shape, a rod-like shape, or the like. However, with respect to the light-emitting nanocrystalline particles, particles having such a shape of particle that the directional property is not marked (for example, particles having a spherical shape, a regular tetrahedron shape, or the like) are preferably used in view of further improving the uniformity and fluidity of the ink composition.

From the viewpoint of easily achieving light emission having a desired wavelength and from the viewpoint of excellent dispersibility and storage stability, the average particle diameter (volume average diameter) of the light-emitting nanocrystalline particles may be 1 nm or more, may be 1.5 nm or more, and may be 2 nm or more. From the viewpoint of easily achieving light emission having a desired wavelength, the average particle diameter (volume average diameter) of the light-emitting nanocrystalline particles may be 40 nm or less, may be 30 nm or less, and may be 20 nm or less. The average particle diameter (volume average diameter) of the light-emitting nanocrystalline particles is obtained by measuring a particle diameter by means of a transmission electron microscope or a scanning electron microscope and calculating a volume average diameter.

Each of the first resin 23a and the second resin 23b may be a cured product of a composition containing a photopolymerizable compound and/or a thermosetting resin. The first resin 23a and the second resin 23b may be the same or different.

The amount of the light-emitting nanocrystalline particles contained in each conversion layer, relative to 100 parts by mass of the resin, may be 80 parts by mass or less, 70 parts by mass or less, 60 parts by mass or less, or 50 parts by mass or less, and may be 1.0 part by mass or more, 3.0 parts by mass or more, 5.0 parts by mass or more, or 10.0 parts by mass or more.

Each of the first conversion layer 21a and the second conversion layer 21b may further contain light scattering particles (details are described below). The amount of the light scattering particles contained in the conversion layer, relative to 100 parts by mass of the resin, may be 0.1 part by mass or more, may be 1 part by mass or more, may be 5 parts by mass or more, may be 7 parts by mass or more, may be 10 parts by mass or more, and may be 12 parts by mass or more. The amount of the contained light scattering particles, relative to 100 parts by mass of the resin, may be 60 parts by mass or less, may be 50 parts by mass or less, may be 40 parts by mass or less, may be 30 parts by mass or less, may be 25 parts by mass or less, may be 20 parts by mass or less, and may be 15 parts by mass or less.

Each of the first conversion layer 21a and the second conversion layer 21b, if necessary, may further contain a molecule having affinity with the light-emitting nanocrystalline particles, a known additive, or another coloring material.

In the first pixel portion 20a and the second pixel portion 20b, a first colored layer 24a and a second colored layer 24b for transmitting the respective lights converted by the conversion layers 21a, 21b and absorbing the incident light are respectively formed on the surfaces of the conversion layers 21a, 21b on the light exit surface side. That is, the first pixel portion 20a has the first conversion layer 21a and the first colored layer 24a in this order from the barrier layer 40 (light incidence surface) side. Similarly, the second pixel portion 20b has the second conversion layer 21b and the second colored layer 24b in this order from the barrier layer 40 (light incidence surface) side.

The first colored layer 24a contains a first coloring material which transmits the light having a wavelength (for example, 605 to 665 nm) converted by the first light-emitting nanocrystalline particles 22a in the first conversion layer 21a and absorbs the incident light (for example, a light having a wavelength in the range of 420 to 480 nm), and a resin having the first coloring material dispersed therein. The first coloring material is a red coloring material. As the red coloring material, for example, at least one member selected from the group consisting of a diketopyrrolopyrrole pigment and an anionic red organic dye can be used.

The second colored layer 24b contains a second coloring material which transmits the light having a wavelength (for example, 500 to 560 nm) converted by the second light-emitting nanocrystalline particles 22b in the second conversion layer 21b and absorbs the incident light (for example, a light having a wavelength in the range of 420 to 480 nm), and a resin having the second coloring material dispersed therein. The second coloring material is a green coloring material. As the green coloring material, for example, at least one member selected from the group consisting of a halogenated copper phthalocyanine pigment, a phthalocyanine green dye, and a mixture of a phthalocyanine blue dye and an azo yellow organic dye can be used.

By virtue of the first colored layer 24a and second colored layer 24b formed on the conversion layers, the color reproducibility of the color filter can be improved. Specifically, for example, when a blue or a semi-white light having a peak at 450 nm is used as the incident light, the incident light is disadvantageously likely to pass through the conversion layers 21a, 21b. In such a case, there is a concern that the incident light and the light which the light-emitting nanocrystalline particles emit (converted light) are mixed in color, leading to a lowering of the color reproducibility. Meanwhile, when the first colored layer 24a and second colored layer 24b are formed on the conversion layers, the incident light is shut out and only the converted light passes through the conversion layers, so that a lowering of the color reproducibility of the color filter can be suppressed.

The third pixel portion 20c has a diffusion layer 25 for diffusing the incident light. The diffusion layer 25 does not contain light-emitting nanocrystalline particles but contains a third resin 23c and light scattering particles 26 dispersed in the third resin 23c. The third pixel portion 20c transmits the incident light (light having a wavelength in the range of 420 to 480 nm), and, for example, has a transmittance of 30% or more with respect to the incident light. Therefore, the third pixel portion 20c functions as a blue pixel portion when using a light source which emits a light having a wavelength in the range of 420 to 480 nm. The transmittance of the third pixel portion 20c can be measured by means of a microspectrophotometer.

The light scattering particles 26 are, for example, inorganic fine particles that are optically inert. Examples of materials constituting the light scattering particles include metals in the form of a simple substance, such as tungsten, zirconium, titanium, platinum, bismuth, rhodium, palladium, silver, tin, and gold; metal oxides, such as silica, barium sulfate, talc, clay, kaolin, alumina white, titanium oxide, magnesium oxide, barium oxide, aluminum oxide, bismuth oxide, zirconium oxide, and zinc oxide; metal carbonates, such as magnesium carbonate, barium carbonate, bismuth subcarbonate, and calcium carbonate; metal hydroxides, such as aluminum hydroxide; composite oxides, such as barium zirconate, calcium zirconate, calcium titanate, barium titanate, and strontium titanate; and metal salts, such as bismuth subnitrate. From the viewpoint of excellent discharge stability and from the viewpoint of more excellent improvement effect for the external quantum efficiency, the light scattering particles preferably contain at least one member selected from the group consisting of titanium oxide, alumina, zirconium oxide, zinc oxide, calcium carbonate, barium sulfate, barium titanate, and silica, more preferably contain at least one member selected from the group consisting of titanium oxide, zirconium oxide, zinc oxide, and barium titanate.

The shape of the light scattering particles may be a spherical shape, a filament shape, an indefinite shape, or the like. The average particle diameter (volume average diameter) of the light scattering particles used may be 0.05 μm or more, and may be 1.0 μm or less. The average particle diameter (volume average diameter) of the light scattering particles used is obtained by, for example, measuring a particle diameter of the individual particles by means of a transmission electron microscope or a scanning electron microscope and calculating a volume average diameter.

The light scattering particles 26 may be the same as or different from the light scattering particles in the first conversion layer 21a and second conversion layer 21b.

In the third pixel portion 20c, a third colored layer 24c for transmitting a light having a wavelength in the range of 420 to 480 nm and absorbing a light having the other wavelength is formed on the surface of the diffusion layer 25 on the light exit surface side. The third colored layer 24c contains a third coloring material which transmits a light having a wavelength in the range of 420 to 480 nm and absorbs a light having the other wavelength, and a resin having the third coloring material dispersed therein. The third coloring material is a blue coloring material. As the blue coloring material, for example, at least one member selected from the group consisting of an ε copper phthalocyanine pigment and a cationic blue organic dye can be used.

The thickness of the pixel portions (first pixel portion 20a, second pixel portion 20b, and third pixel portion 20c) may be, for example, 1 μm or more, and may be 2 μm or more, and may be 3 μm or more. The thickness of the pixel portions (first pixel portion 20a, second pixel portion 20b, and third pixel portion 20c) may be, for example, 30 μm or less, and may be 20 μm or less, and may be 15 μm or less.

The reflective film 30 is a film having a reflectance of 50% or more with respect to a light in the visible light region (wavelength: entire region of 380 to 750 nm). The reflectance with respect to a light in the visible light region is defined as a value measured by a spectral reflectance measurement apparatus.

The reflective film 30 is formed on at least part of the side of the bank 10 (surface in contact with the pixel portions 20), and may be formed on all of the side of the bank 10, and, from the viewpoint of improving the light conversion efficiency of the color filter, the reflective film 30 preferably is formed on all of the side of the bank 10.

Examples of materials constituting the reflective film 30 include metals. The reflective film 30 may be formed from a single type of metal, and may be formed from an alloy of two or more types of metals. The metal may be formed from, for example, aluminum, neodymium, silver, rhodium, or an alloy thereof. The metal preferably contains aluminum. The reflective film 30 is preferably formed from a metal containing aluminum, more preferably formed from a metal containing aluminum and another metal, further preferably formed from a metal containing aluminum and neodymium.

The thickness of the reflective film 30 may be 50 nm or more, 100 nm or more, or 150 nm or more, and may be 300 nm or less, 250 nm or less, or 200 nm or less. The thickness of the reflective film is measured by means of a stylus profiler, a white light interference thickness meter, or an electron microscope.

By virtue of the reflective film 30 formed on the side of the bank, the probability of the phenomenon that the incident light is reflected by the reflective film 30 and absorbed and converted by the light-emitting nanocrystalline particles 22a, 22b is improved. In addition, the probability of the phenomenon that the light having a wavelength converted by the light-emitting nanocrystalline particles 22a, 22b (converted light) is reflected by the reflective film 30 and permitted to exit from the color filter 100 (the amount of the exit light) is also improved. Accordingly, in the case where the reflective film 30 is formed, absorption of the light (incident light and converted light) by the bank 10 is suppressed, as compared to that in the case where the reflective film is not formed, making it possible to improve the light conversion efficiency of the color filter.

Examples of materials for the barrier layer 40 include SiNₓ, SiO₂, and Al₂O₃. The thickness of the barrier layer 40 may be 0.01 μm or more, 0.1 μm or more, or 0.5 μm or more, and may be 10 μm or less, 5 μm or less, or 1 μm or less.

The substrate 50 is a transparent substrate having light transmission properties, and a transparent glass substrate, such as quartz glass, Pyrex (registered trademark) glass, or a synthetic quartz plate, a transparent flexible substrate, such as a transparent resin film or a resin film for optical use, or the like can be used. Of these, a glass substrate made of non-alkali glass containing no alkaline component in the glass is preferably used. Specifically, preferred are “7059 Glass”, “1737 Glass”, “EAGLE 2000”, and “EAGLE XG”, each of which is manufactured by Corning Inc.; “AN100”, manufactured by AGC Inc.; and “OA-10G” and “OA-11”, each of which is manufactured by Nippon Electric Glass Co., Ltd. These are materials having such a small thermal expansion coefficient that the dimensional stability and operation properties in a high-temperature heating treatment are excellent.

The color filter 100 having the above-mentioned conversion layers 21a, 21b is advantageously used when using a light source which emits a light having a wavelength in the range of 420 to 480 nm.

The color filter 100 is produced by, for example, the following method. A bank 10 is first formed so as to be patterned on a substrate 50, and then a reflective film 30 is formed on the substrate 50 and bank 10. The reflective film 30 formed in regions that need no formation of the reflective film 30, such as the pixel portion formation region and the upper bottom of the bank (surface of the bank opposite to the surface in contact with the substrate), is removed. An ink composition for forming a colored layer containing a pigment and a curable component is selectively applied by an ink-jet method to the pixel portion formation region defined by the bank 10 on the substrate 50, and the ink composition for forming a colored layer is cured by irradiation with an active energy ray. An ink composition for forming a conversion layer (ink-jet ink) containing light-emitting nanocrystalline particles and a curable component (component which is curable due to heat or a light), or an ink composition for forming a diffusion layer containing light scattering particles and a curable component is selectively applied by an ink-jet method to the colored layer 24 formed in the pixel portion formation region, and the ink composition is cured by irradiation with an active energy ray.

The colored layer 24 may not be formed in the pixel portion formation region defined by the bank on the substrate. In this case, the ink composition is selectively applied by an ink-jet method to the pixel portion formation region defined by the bank 10 on the substrate 50, and the ink composition is cured by irradiation with an active energy ray, forming a conversion layer 21 or diffusion layer 25 on the surface of the substrate 50 on the light incidence surface side.

As an example of the method for forming the bank 10, there can be mentioned a method in which a metal thin film of chromium or the like, or a thin film of a resin composition containing a resin is formed in a region corresponding to the boundary between the pixel portions 20 on the substrate 50 on one surface side, and the resultant thin film is subjected to patterning. The metal thin film can be formed by, for example, a sputtering method, a vacuum vapor deposition method, or the like, and the thin film of a resin composition containing a resin can be formed by, for example, an application or printing method. Examples of methods for patterning include a photolithography method.

Examples of ink-jet methods include a Bubblejet (registered trademark) method using an electrothermal conversion element as an energy generating device, and a piezojet method using a piezoelectric device.

When the ink composition is cured by irradiation with an active energy ray (for example, an ultraviolet light), for example, a mercury lamp, a metal halide lamp, a xenon lamp, an LED, or the like may be used. The wavelength of the light for irradiation may be, for example, 200 nm or more, and may be 440 nm or less. The irradiation dose may be, for example, 10 mJ/cm² or more, and may be 4,000 mJ/cm² or less.

As a method for removing the reflective film 30 from the regions that need no formation of the reflective film 30, there can be mentioned, for example, a wet etching method, a dry etching method, and a lift-off method.

The barrier layer 40 can be formed by a chemical vapor deposition method (CVD), an atomic layer deposition method (ALD), a vapor deposition method, a sputtering method, or the like.

The opening ratio in the color filter 100 (area ratio of the pixel portions 20 to the whole of the color filter 100, as viewed from the direction opposite to the direction of incidence of the light) may be, for example, 60% or more, 70% or more, or 80% or more, and may be 95% or less, 90% or less, or 85% or less.

Hereinabove, the color filter and an embodiment of the method for producing the color filter were described, but the present invention is not limited to the above-mentioned embodiments.

For example, the color filter 100 may have, instead of the third pixel portion 20c, a pixel portion (blue pixel portion) having a conversion layer containing a fourth resin and blue light-emitting nanocrystalline particles dispersed in the fourth resin. Further, the conversion layer may contain nanocrystalline particles which emit a light of a color other than red, green, and blue (for example, yellow). In these cases, it is preferred that the light-emitting nanocrystalline particles contained in the pixel portions in the conversion layer have an absorption maximum wavelength in the same wavelength region. Further, the conversion layer may contain a coloring material other than the light-emitting nanocrystalline particles (such as a pigment or a dye).

Further, part of or all of the first colored layer 24a, second colored layer 24b, and third colored layer 24c may not be formed. The barrier layer 40 may not be formed.

Further, the color filter may have a protective layer (overcoat layer) between the barrier layer and the conversion layer in the pixel portions. The protective layer is formed not only for planarizing the color filter but also for preventing the components contained in the pixel portions from dissolving and going out of the pixel portions. As a material constituting the protective layer, a material used as a protective layer for a known color filter (for example, an epoxy resin or (a)an (meth)acrylate resin) can be used.

Further, in the production of the color filter, the pixel portions may be formed by a photolithography method, instead of an ink-jet method. In this case, the ink composition in a layer form is first applied to a substrate to form an ink composition layer. Then, the ink composition layer is subjected to exposure so as to be patterned, followed by development using a developer. Thus, pixel portions composed of a cured product of the ink composition are formed. The developer is generally alkaline, and therefore, as a material for the ink composition, an alkali-soluble material is used. From the viewpoint of efficiency of use of the material, the ink-jet method is more excellent than the photolithography method. The reason for this is that the photolithography method has a principle that almost ⅔ or more of the material is removed, making the material useless. Therefore, in the present embodiment, it is preferred that the pixel portions are formed by an ink-jet method using an ink-jet ink.

### REFERENCE SIGNS LIST

10: Bank

20: Pixel portion

20a: First pixel portion

20b: Second pixel portion

20c: Third pixel portion

21: Conversion layer

21a: First conversion layer

21b: Second conversion layer

22a: First light-emitting nanocrystalline particle

22b: Second light-emitting nanocrystalline particle

23a: First resin

23b: Second resin

23c: Third resin

24: Colored layer

24a: First colored layer

24b: Second colored layer

24c: Third colored layer

25: Diffusion layer

26: Light scattering particle

30: Reflective film

40: Barrier layer

100: Color filter

1. A color filter for converting an incident light from one surface of the color filter to a light having a wavelength different from that of the incident light and permitting the converted light to exit from another surface of the color filter,
the color filter comprising:
a bank having a plurality of opening portions and being formed to extend from the another surface to the one surface of the color filter;
a plurality of pixel portions formed in the respective opening portions; and
a reflective film formed so as to cover at least part of the side of the bank,
the pixel portions having a pixel portion having a conversion layer containing light-emitting nanocrystalline particles,
wherein the ratio of the height of the bank to the width of the bank is 0.5 or more, and
wherein the angle between the side of the bank and the another surface of the color filter is 60 to 90°.

2. The color filter according to claim 1, wherein a colored layer for transmitting the light converted by the conversion layer and absorbing the incident light is formed on the conversion layer on the another surface side of the color filter.

3. The color filter according to claim 1, wherein a barrier layer for protecting the conversion layer is formed on the conversion layer on the one surface side of the color filter.
